(19) United States
(12) Patent Application Publication
(10) Pub. No.: US 2022/0299995 A1
(43) Pub. Date: Sep. 22, 2022

(54) Autonomous Vehicle Warehouse Inventory Inspection and Management

(71) Applicant: Vimaan Robotics, Inc., Santa Clara, CA (US)

(72) Inventors: Srinivasan K. Ganapathi, Palo Alto, CA (US); Sumil Majithia, Cupertino, CA (US); Javier Cisneros, Sunnyvale, CA (US); Michael A, Stearns, Milpitas, CA (US); Kunal Manoj Agrawal, Ahmedabad (IN); Shubham Chechani, Bhilwara (IN); Nikolay Skarbnik, San Jose, CA (US); Marc Mignard, Los Gatos, CA (US); Dheepak Nand Kishore Khatri, Milpitas, CA (US)

(21) Appl. No.: 17/638,972

(22) PCT Filed: Sep. 4, 2020
(86) PCT No.: PCT/US20/49364

§ 371 Date: Feb. 28, 2022

Related U.S. Application Data
(60) Provisional application No. 62/895,824, filed on Sep. 4, 2019.

(51) Int. Cl. G05D 1/00; B65G 1/137; B65G 1/04

(52) U.S. Cl. CPC G05D 1/0094; G05D 1/0088; B65G 1/1373; B65G 1/0485; G05D 2201/0216

(57) ABSTRACT

Autonomous vehicle inventory inspection and management is provided for a GPS-denied indoor warehouse with the objective of achieving fast, yet accurate warehouse inventory assessment. The warehouse stores inventory organized in a distributed and substantially parallel fashion. Passive identification markers are located on the racks for aiding navigation of the autonomous vehicle. Travel paths for the autonomous vehicle are predefined. They are relatively straight paths in between the racks, substantially constant and lateral first distance relative to at least one of two racks along its row, a substantially constant first height relative to a warehouse floor and a substantially constant speed for the autonomous vehicle. These requirements are important to attain the objective of faster, yet accurate inventory inspection and management. During travel, acquisition systems capture information of the inventory, which is synchronized with a digital management system. Inventory is reconstructed providing a digital twin of the warehouse inventory.

### FIELD OF THE INVENTION

This invention relates to autonomous vehicles for warehouse inventory inspection methods and systems. This invention also relates to technology to operate an autonomous vehicle through a warehouse in a pre-defined path between warehouse racks and collect data.

### BACKGROUND OF THE INVENTION

Inventory in warehouses is tracked by periodically scanning the barcode of the item and the barcode of the location that holds the item. This process is repeated across an entire warehouse, which may have as many as 100,000 items at as many locations. To ensure accuracy, the inventory is periodically scanned, sometimes daily, sometimes weekly, or sometimes only quarterly. This process is very labor intensive, and requires trained workers that are dedicated to this task. Workers are also required to use forklifts so that they may elevate themselves to the upper reaches of the shelves and racks where the items may be stored. In addition to cost, the use of forklifts makes such operations inherently unsafe. Finally, this also adds cost to the entire operation.

To counter some of the problems, technologies have been proposed to minimize or altogether eliminate the human labor component of inventory tracking. For example, drones have been proposed to fly to each specific location, search for a barcode, and scan both the item barcode and the location barcode, and compare it against the database. However, this process still remains very time consuming. For example, it takes an excessive amount of time for the drone to locate the barcode and scan it, and then move to the next location. Further, this approach does not provide any information beyond the barcode, such as the physical state of the inventory.

The objective of the invention is to provide technology to enable fast, yet accurate and more comprehensive inventory assessment and management.

### SUMMARY OF THE INVENTION

The present invention provides a method and system for autonomous vehicle inventory inspection and management in a warehouse. A warehouse is defined as a building for storing goods, and includes retail stores, distribution centers and also e-commerce fulfilment centers.

In one example the warehouse is an indoor warehouse with rows of racks having shelves storing inventory. The racks are organized in a distributed and substantially parallel fashion. Passive identification markers (e.g. labels, tags or barcodes) are located on the racks for aiding navigation of the autonomous vehicle. In one example the passive identification markers are distributed (e.g. either evenly or unevenly, every one or few meters or so). In the aiding for navigation, the passive identification markers are also utilized for course correction of the travel path.

In the examples of an indoor warehouse, one would have a GPS-denied environment or a GPS environment with poor and inconsistent signal. Therefore, it has been the goal of this invention to develop technology that operates without the use of or not relying on GPS for navigation of the autonomous vehicle. Furthermore, the technology provided herein is functional in a light-poor, even dark indoor warehouse or an environment with 50 Lumens or lower.

A first path is defined in the rows (or aisles) between the racks by a computer implemented digital warehouse management system. This defined first path is a prescribed relatively straight path along the aisles in between the racks; it defines a substantially constant and lateral first distance relative to at least one of two racks along its row, a substantially constant first height relative to a warehouse floor and a substantially constant speed (about 0.1 to 3.5 m/sec) for the autonomous vehicle.

The substantially constant height and speed are crucial to attain the objective of this invention, which is fast, yet accurate inventory assessment and management. Having these variables be more or less constant reduces computational requirements such as for example correction of variation in these parameters. In other words, the computational algorithms are based on having these parameters constant providing for relatively simpler computation as they don't have to include image processing algorithms accounting for any such fluctuations. Obviously stopping and too slow of a speed does not benefit the need for processing lots of inventory data.

Likewise, there is a maximum speed where one could still achieve accuracy for inventory assessment/analysis, and beyond which it is not possible to acquire high quality data to enable proper computer vision processing of the acquired inventory information.

An autonomous vehicle (ground/driving vehicle or flying vehicle) is docked at a “base station”. The autonomous vehicle has at least two data acquisition systems, with at least one onboard camera and at least one onboard inertial sensor.

At predefined intervals, determined and set by the computer implemented digital warehouse management system and programmed into the autonomous vehicle, the autonomous vehicle is launched or takes off from the base station to continuously travel along the defined first path at the substantially constant speed until the program instructs it to return to the base station. During travel, the at least one onboard camera captures the passive identification markers located on the racks and together with the at least one inertial sensor ensures travel according to the defined path. Furthermore, the at least two data acquisition systems capture information of the inventory, the racks and position of the inventory on the racks. During travel, the passive identification markers may be used to correct the course of the autonomous vehicle and reset its position so as to stay on the defined path.

Examples of the captured information of the inventory includes information about contour of the inventory, dimension of the inventory, image of the inventory, location of horizontal bars, vertical bars and uprights of the racks, distances of one or more faces of the inventory from the at least one onboard camera, color of the inventory on the shelves, color of the racks, or a combination thereof.

The captured data is synchronized with instantaneous locations of the autonomous vehicle with the computer implemented digital warehouse management system.

Inventory information is reconstructed by the computer implemented digital warehouse management system based on the captured information of the inventory relative to a position on the rack. By repeating this process for all the shelves and racks in a given warehouse, the reconstructed inventory becomes like a digital twin of the physical inventory in the warehouse.

In one embodiment, the computer implemented digital warehouse management system is further configured to digitally process the captured data for the purpose of determining label or barcode readings, inventory item counting, inventory change detection, safety inspection, anomaly detection, workflow, inventory location accuracy, inventory location error detection, inventory label accuracy, inventory label error detection, inventory damage detection, inventory relocation, space utilization, space measurement, shipment errors, shipment or inventory inquiries, or any combination thereof.

In another embodiment, the defined first path is augmented with a second path also defined in the rows (aisles) between the racks. The defined second path is a prescribed relatively straight path along the rows in between the racks; it defines a substantially constant and lateral second distance relative to at least one of two racks along its row, a substantially constant second height relative to a warehouse floor and a substantially constant speed for the autonomous vehicle, wherein the defined first path and second path are different from each other.

The passive identification markers for aiding navigation of the autonomous vehicle are further used for aiding in making corrections during travel to maintain the substantially constant and lateral first distance, the substantially constant first height, the substantially constant speed for the autonomous vehicle, or a combination thereof. Likewise, the passive identification markers for aiding navigation of the autonomous vehicle are further used for aiding in making corrections during travel to maintain the substantially constant and lateral second distance, the substantially constant second height, the substantially constant speed for the autonomous vehicle, or a combination thereof.

An advantage of this embodiment of this invention is that one can enable a substantially longer flight path by following this “zigzag” pattern: the autonomous vehicle traverses the entire row between the racks, then changes height, and travels in the opposite direction to capture inventory information from a higher or a lower shelf. Alternatively, when the autonomous vehicle has traversed the row for the first time, it can also maintain the same height but now move laterally in the aisle between the racks so as to maintain a second constant lateral distance from the rack and travel in the opposite direction, but now capture information from the rack that is across the row (aisle) from the first rack. This combination of paths allows a greater amount of information to be captured by the autonomous vehicle during a single mission and increases overall efficiency of the system.

### BRIEF DESCRIPTION OF THE DRAWINGS

FIG. 1 shows according to an exemplary embodiment of the invention a robotics drone-based inventory management system.

FIG. 2 shows according to an exemplary embodiment of the invention an example path followed by the drone in warehouse while scanning inventory, along with an example calculation of the cruise speed and the number of locations scanned during a mission.

FIG. 3 shows according to an exemplary embodiment of the invention at least part of the method and system of the inventory scanning solution.

FIG. 4 shows according to an exemplary embodiment of the invention the extraction of pallet label information and location information from images.

FIG. 5 shows according to an exemplary embodiment of the invention computer vision to count boxes in a stack.

FIG. 6 shows according to an exemplary embodiment of the invention anomalies and changes detected by computer vision software.

FIG. 7 shows according to an exemplary embodiment of the invention change detection between two scenes.

FIG. 8 shows according to an exemplary embodiment of the invention a data flow and architecture.

### DETAILED DESCRIPTION

The present invention provides a method and system for an Unmanned Vehicle (UV) such as, but not limited to, a terrestrial vehicle or an aerial drone to autonomously navigate between warehouse pallet racks using visual inertial odometry to determine the UV's position. While traversing within a row (aisle) between pallet racks, the UV maintains an offset position between pallet racks and obtains, using UV onboard digital cameras, imagery of the pallet racks and associated stored inventory.

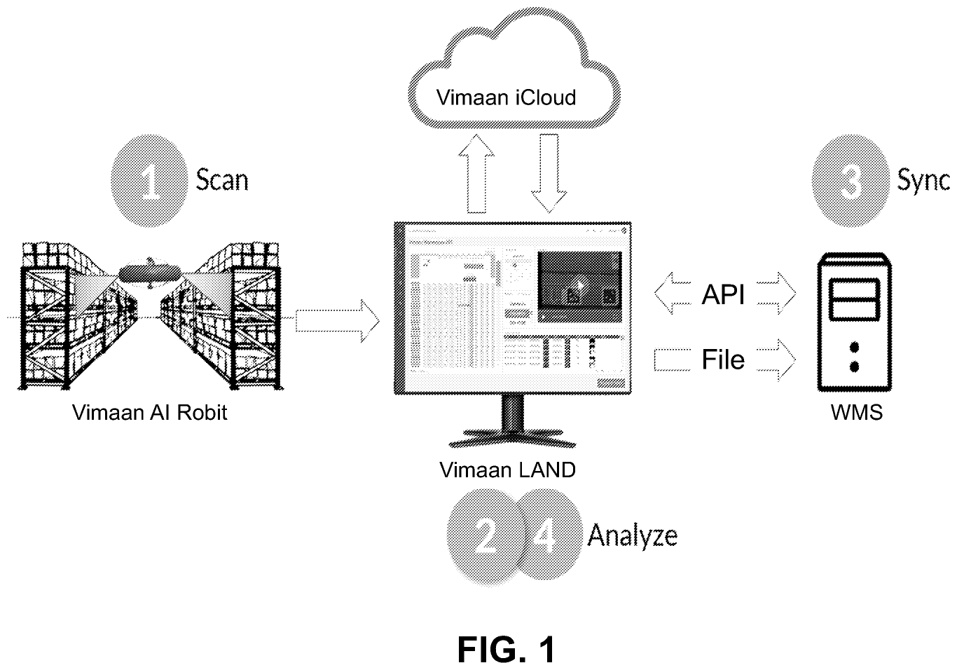

Embodiments of the invention automate and significantly speed-up the manual process of inventory counting in large warehouses with greater accuracy. As shown in FIG. 1, an indoor drone scans inventory stored on industry standard rack systems in a warehouse (Step 1). Next, the data collected by the UV (AlRobot) are uploaded to a system (Location Analytics Dashboard/LAND) for analysis (Step 2). The system can then sync with the customer's Warehouse Management System (WMS) to update inventory records, or query additional information from the customer's WMS for further analysis (Step 3). The end-user may interact with a web-based (CLOUD) user interface to view reports, query the data, and visualize information about the inventory (Step 4).

The UV or drone is “docked” indoors on a “base station”. At pre-defined intervals, the UV receives commands from the Location Analytics Dashboard System which contains the instructions for the mission that the UV needs to follow. The UV then initiates motion or takes off autonomously, and then autonomously follows a prescribed path (according to the commanded mission) along a warehouse aisle between racks and captures a variety of information from the inventory stocked on the shelves. It then autonomously “docks with” or “lands on” a base station and automatically recharges the battery and also “uploads” the captured images and other sensor information to the LAND system computers which use Computer Vision (CV) image processing software to generate warehouse specific data that seamlessly integrates into the customer's Warehouse Management System (WMS) software database for real-time visibility.

The system of this invention generates, in real-time, more and richer data than what is possible by human inventory staff. Customers have indicated that human counters can visit 30-60 “bin locations” per hour using forklifts and other manual vehicles. The solution provided herein can visit as many as 1,500 bin locations per hour with higher levels of accuracy. In addition, the system of this invention creates a 3D and visual “digital twin” of the inventory to manage the business in new and more efficient ways. The system is also able to archive data that provides additional business benefits and substantial return on investment.

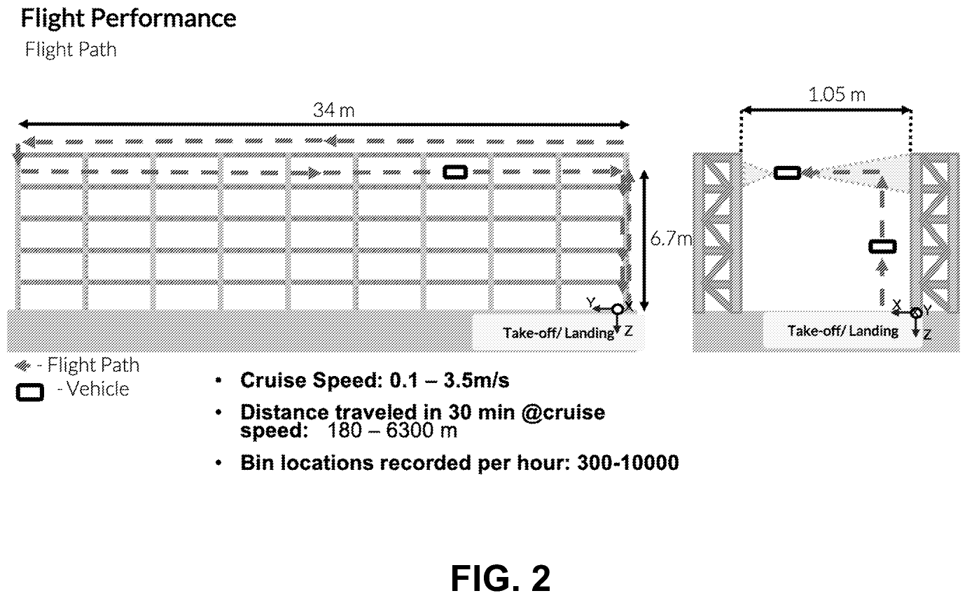

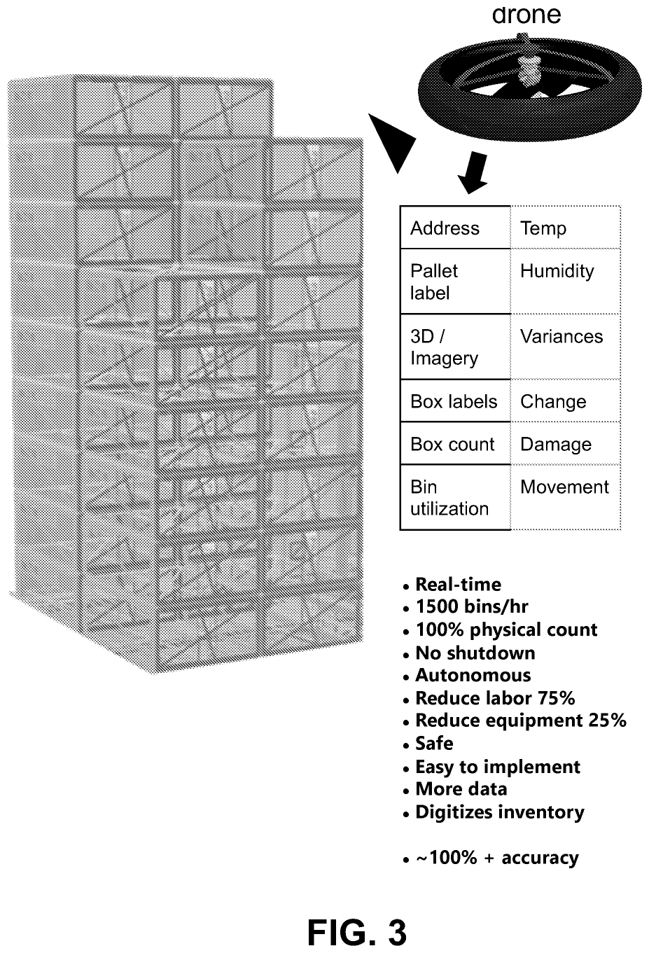

The path followed by the UV is usually in the form of a straight line along the aisles in between the racks that it is scanning, as shown in FIG. 2. As shown in FIG. 2, the UV may have different types of cameras looking at racks and shelves on both sides of the aisle. It traverses both “sides” of the aisle at a more or less constant speed (example 0.1-3.5 m/sec) and captures images, location, distance information of the inventory and racks from the camera, temperature and relative humidity information, etc. This information is later consolidated by the computer vision algorithms and analyzed to provide the warehouse operator a comprehensive view of the warehouse, thus creating a digital twin of the warehouse that is updated frequently as soon as each mission of the UV is completed.

Indoor Autonomy

In an outdoor environment, it is much easier to track and control position of a UV because of the presence of a GPS signal. However, in an indoor environment, i.e. a GPS denied environment, it is not easy to travel or fly along a tightly prescribed path in relation to the racks in the warehouse. There are sensors that allow one to travel or fly in a “straight line”, but in the case of this invention, this path needs to be parallel to (i.e., constant distance from) one of the racks in the warehouse, and follow along the aisle precisely; otherwise, in the course of traversing a long aisle, any angular drift could result in collisions between the UV and the racks. In addition, any angular drift also increases the distances between the UV's sensors and camera and the racks (or decreases it) over time and compromises the image quality and the ability to process the images. Therefore, the system depends on the drone tightly following the path prescribed—it has to be along the aisles at a (more or less) constant distance within a few centimeters of a prescribed distance (which could be 30-100 cm) from one of the neighboring racks, and at a constant height within a few centimeters of a target height (which would vary according to the height of the shelf being scanned) from the ground.

The constant distance and height are accomplished with a combination of vision, passive/fiducial markers located along the aisle, and in addition, inertial sensors and other supplementary sensors, such as sonar or laser-based range finders and cameras—all located on the UV and operating in concert. The data from these various sensors—inertial sensors, magnetometers, pressure sensors, range finders, cameras and distance sensors—is fused appropriately to enable this tight adherence to a prescribed path. Most importantly, the “infrastructure” such as the markers or the labels that are located on the racks which the UV uses for navigation is all “passive”—these can be merely paper or plastic stickers that are affixed to various locations, and they do not require power, maintenance or battery changeouts. This is in contrast to solutions that use ‘active tags” that require power, such as RF beacons and antennas, or LED patterns, or motion capture and control units to track location and control position of the drone precisely. In one embodiment, barcode tags are used, e.g. 2D barcode tags. In another embodiment, the labels affixed by the warehouse on the racks for locating inventory can be used. In all of these cases, no ongoing “maintenance”—such as battery changes, wiring or other calibrations—are necessary.

Using this combination of sensors and cameras and control methodologies, the UV is able to control its position to within a few centimeters from its prescribed path. This is despite multiple corner cases, such as varying levels of light in the warehouse, the presence of fans that disturb the airflow, the sudden opening of doors or flashing of lights from forklifts, presence of significant amounts of metal in the racks, the reflections of light from the racks or the inventory, etc.

Prior art solutions that read barcodes autonomously using drones in a warehouse have the following procedure. They navigate to a barcode, identify the barcode, then “hover” in front of that location, then turn on the barcode scanner and scan the barcode and then send that information to a database. There are two major differences/disadvantages compared to what is described in the present invention. First, this prior art solution is a very slow process, where one needs cameras, barcode scanners and significant computational power on the drone to process and identify the barcode on the image in real time. Then the drone centers itself in that location and captures the barcode. To do this at tens of thousands of locations is a very time-consuming process, and the throughput is only marginally better than a manual solution, and can only achieve 50-100 locations per hour. In contrast, with the solution provided in this invention, since the UV is traveling continuously or the drone is flying continuously without stopping, and the sensor and camera technology along with the computer vision algorithms are configured to capture and process images and other captured information in a rapid manner without stopping at each location along the way, the UV is able to provide information about the inventory such as images, location, distance and color at about 20 times the speed of the prior art described above, which is over 1000 locations per hour.

A 20λ data collection rate compared to prior systems originates from the ability of embodiments in this invention to fly at about 0.1 to 3.5 m/sec and cover a 50-200 m long aisle in approximately 5-15 minutes and simultaneously capture all the above described information about the inventory labels as well as the state of the inventory. This is not possible by a human who uses a forklift to go to a particular location, identify the barcode and uses his scan gun to scan it.

In one embodiment of this invention, the UV and the associated computer vision algorithms capture an entire label for an inventory item (i.e. not just a barcode, but also all the lettering and logos), the size of the box, the spacing between the boxes, whether there is any damage to the box, whether it is different from the previous day's capture, the temperature of the location, etc. This has been made possible through the use of both RGB as well as 3D depth cameras which allow us to reconstruct the warehouse in a digital manner and provide analytics on a host of parameters beyond just the barcode label and the location.

In one embodiment, the speed range used by the drone to fly at constant speed along the aisles is about 0.1 to 3.5 m/sec. The drone flies a zigzag path as it goes from one level to the next, or one side of the aisle to the other—which includes a horizontal path with the sensors at a constant height, then changing the height or lateral location of the sensors and traveling in the reverse direction at the new height or new lateral location within the aisle. Data is typically captured during the long horizontal portion of the flight.

Data collected by one camera on one side captures high resolution information from the “near side” aisle, from which it captures labels, barcodes, and other small lettering. The camera on the other side captures 3D and distance information. There are also sensors, such as inertial sensors, magnetometers and altitude sensors on the UV that simultaneously record the exact position of the UV at a given instant, so that it can be correlated with the images captured by the cameras. Other temperature and humidity sensors capture temperature, humidity, etc. continuously and that is also correlated with the position.

From the images and position information, one or more computer algorithms stitch together different frames, zoom in and identify text and other information, identify the edges of the boxes and pallets, measure the heights, spacings, etc.; review the shapes of these pallets to see if there is any damage, compare against previously captured data to see if there is any change (may be theft or incorrectly picked items), etc. This can be compared against the warehouse data management system to correct errors, and provide a lot more detail than is available. We can also do the same with the shipping areas within the warehouse to ensure that shipments are correctly routed and have the proper labels (customs, etc.).

The UV could be equipped with one or more processors and a computer storage medium storing instructions that when executed cause the processors to perform operations such as a computerized method performed by the UV. This method could include a non-transitory computer storage medium with instructions that when executed by the processors cause the UV to perform operations such as:
1. Autonomously navigate using passive/fiducial markers (external command based on marker). Examples of fiducial markers are: QR code, wireless, existing features, labels on the rack, packing labels, or other structural markings.
2. Autonomously navigate past pallet rack in a “zig/zag” flight path (horizontal or vertical).
3. Autonomously navigate past a structure and obtain imagery using at least one camera, with offset from first structure.
4. Autonomously navigate between pallet racks, obtain imagery, process imagery, assign pallet rack locations to images for search/retrieval via user interface.

In still further embodiments of the invention, a technology is provided to process data acquired from the UV to not only create a new type of “ground truth” or “system of record” that accurately captures the state and location of inventory in the warehouse, but also a way to interface this with the Warehouse Management System (WMS) database and alert the warehouse manager to discrepancies between actual reality and what is reported in the WMS.

With this technology, the WMS may be appropriately updated and provide an accurate record in near real time. In particular, further embodiments of this invention allow the warehouse inventory to be:
Viewed and updated in close to real time,
Alert warehouse managers to any “event” of interest—such as wrongly tagged pallets, wrongly placed pallets, temperature or humidity deviations from specification, incorrectly targeted shipments, placement of shipment labels, damage to boxes or pallets, safety or security concerns, etc.
Provide remote “visualization” of all corners or locations in the warehouse from any client device, and/or
Highlight changes that have occurred at a given location.

Data Processing and Interfacing with WMS

There is a variety of information that is extracted from the images, sensor information and depth maps. Some examples of these types of processing as well as how it interfaces with the WMS is provided below.

1. Barcode Reading

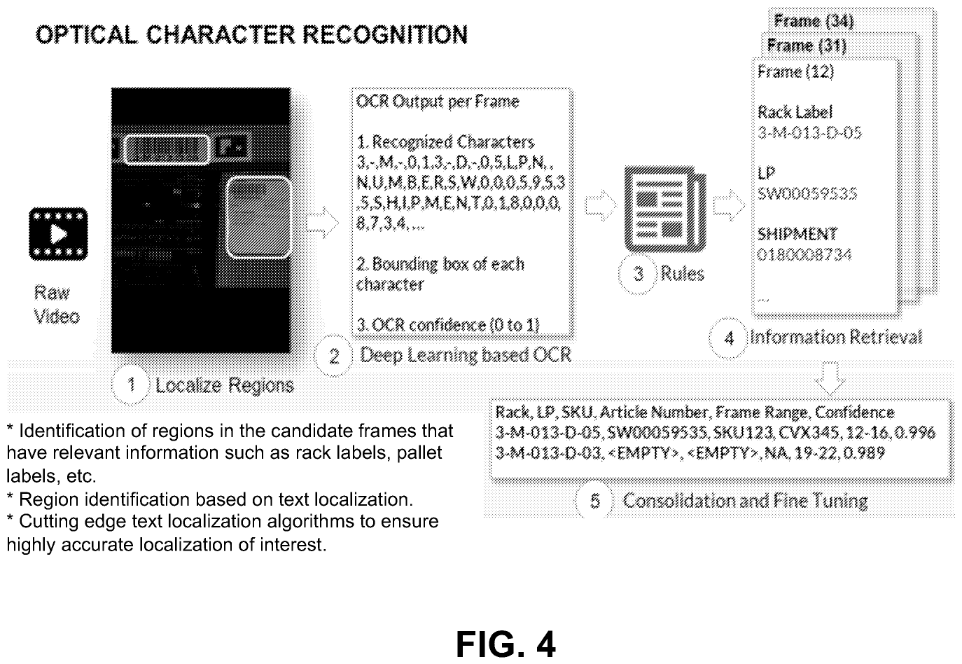

FIG. 4 shows an example of how computer vision technology is used to extract not only barcode information, but also other information from a label, such as quantity, size, etc. from the label. It also captures the rack label information to associate the pallet location with the rack bin location. This process is described in more detail below:
1. Perform a barcode recognition and optical character recognition algorithm on selected frames from the camera. This can be done using a traditional deep learning model, first by detecting the location of the text box, and then by conducting text recognition within each of the text boxes, also using machine learning models, such as Tesseract. Once the text within each box is identified, the pre-specified character strings from the text that correspond to the text of interest, such as label number, quantity, SKU number, etc. are extracted, and the rest of the text can be discarded.
2. A similar process can be followed to read the location addresses that are present on each horizontal bar that make up the shelves and racks in the warehouse.
3. Once both pallet labels and rack location labels have been read and extracted by the computer vision algorithm, they are matched up both in location and time of image acquisition and can be associated with each other.

2. Item Counting

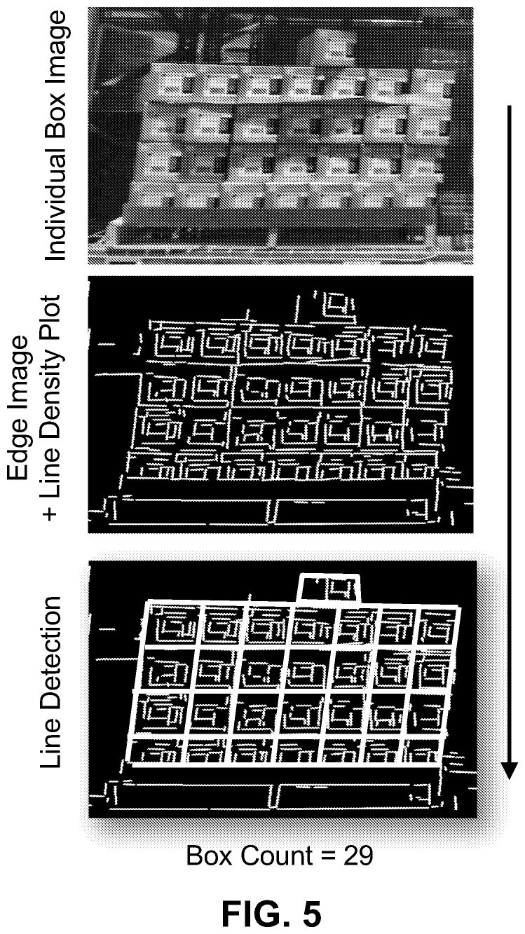

FIG. 5 shows an example of how computer vision technology is used to count the number of boxes in a stack of boxes based on the inventory information captured by the UV. This is very useful for the inventory manager to understand the number of sub-items at a given location—information that they cannot get currently from existing automated scanning methods. This is done by training a computer vision based deep learning model to understand the delineations or boundaries between various boxes, and to recognize the various boxes on a pallet. The model can also be trained to recognize a pallet.

3. Change Detection and Safety/Anomaly Detection

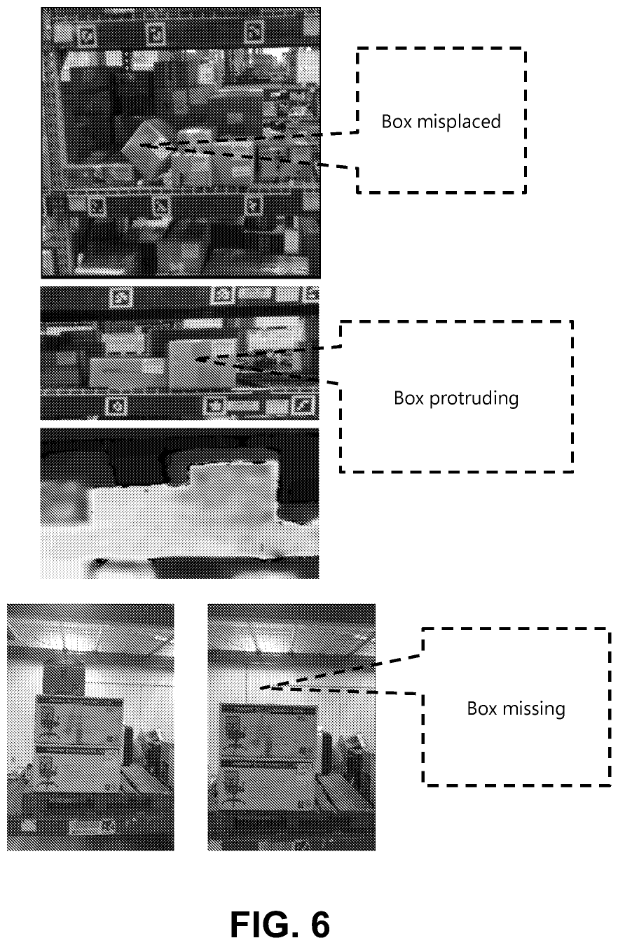

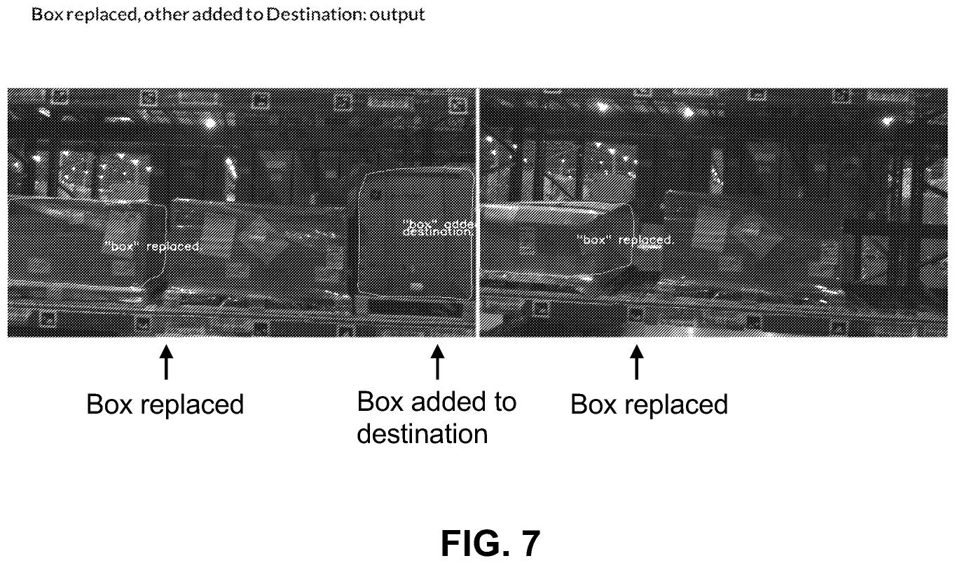

FIG. 6 and FIG. 7 show an example of how computer vision technology is used to look for safety anomalies or changes from prior dates. This allows the warehouse manager to quickly fix any issues that are a result of pilferage, missed shipments, safety issues, etc. The Change Detection works as a natural extension to the “box counting” algorithm described above: By comparing the number of boxes and their locations between two time periods, it is relatively straightforward to determine if there has been any temporal change in the “scene” as viewed by the UV.

Data Workflow

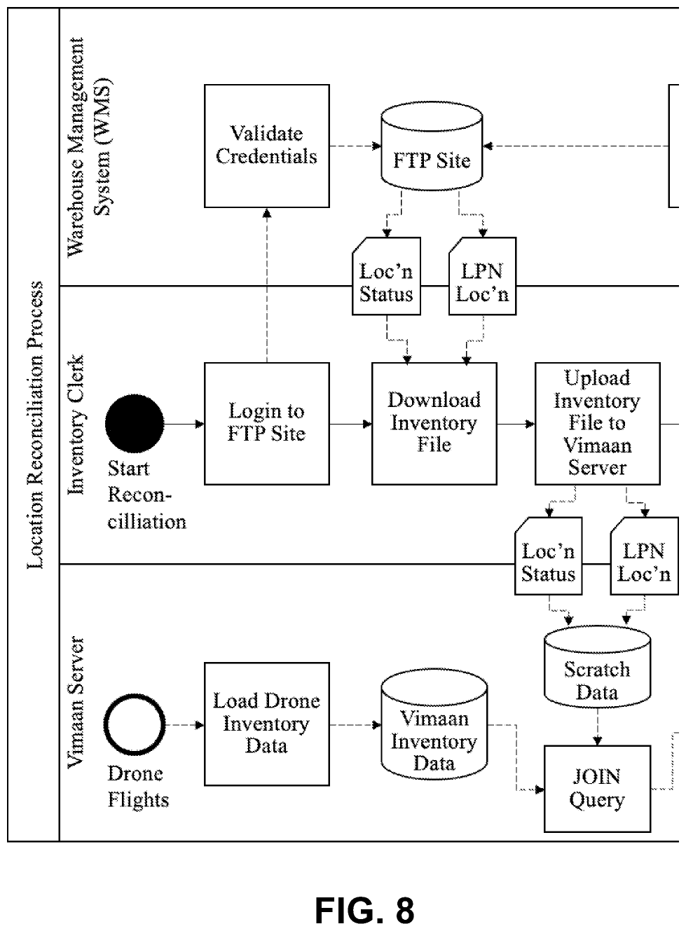

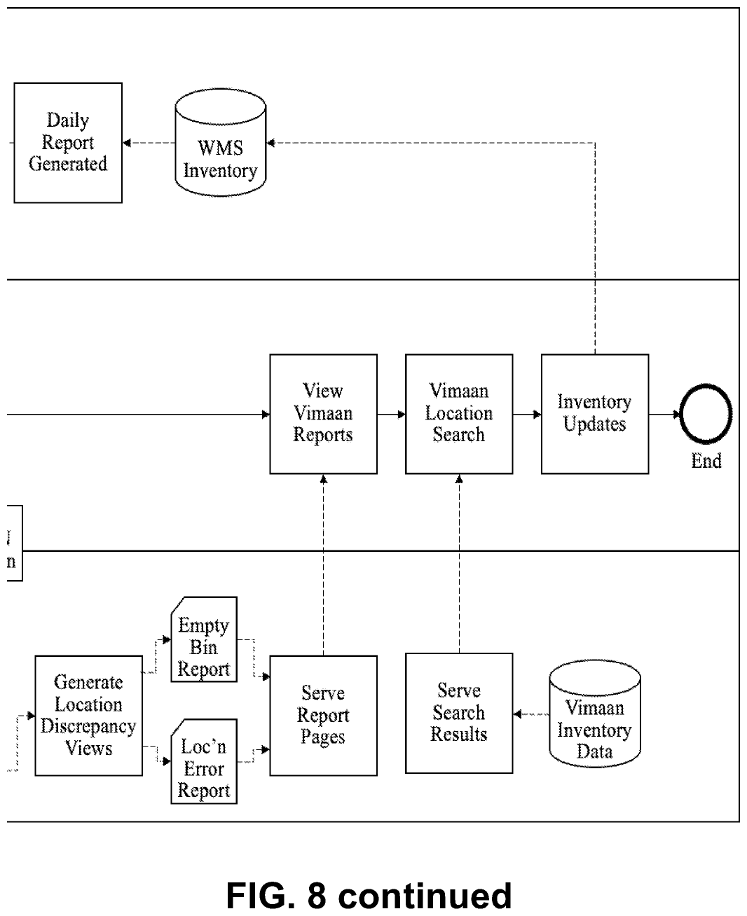

The flow of data after it is uploaded from the UV to the LAND system is shown in FIG. 8. Once the UV has uploaded the sensor and camera data it has collected from its mission to the LAND system and the Computer Vision algorithms have generated information on inventory status and locations in the warehouse, this information is compared against the corresponding data contained in the Warehouse Management System as maintained by the warehouse. Discrepancies between the two databases are a reflection of the “errors” in the database: items that are not where they should be, items that are wrongly labeled, or items that are not in the state they should be. The LAND system highlights all such discrepancies and enables the warehouse manager to immediately correct the discrepancies. Key features of the embodiments are Inventory Location Inaccuracy, Inventory Location Error Detection, Label Inaccuracy, Label Error Detection, Inventory Damage, Damage Detection, Unplanned/Un-authorized Inventory Movement, Change Detection, Inefficient Space Utilization, Space Utilization Measurement, Shipment Errors, and/or Shipment QA.

Inventory Location Inaccuracy

Inventory is routinely scanned as it is received at a warehouse. However, as it goes through processes of put-away in the shelves, movement, repackaging, consolidation, picking, and shipment, its location is often not accurately recorded. As the size and complexity of warehouse operations increases, along with demand for rapid order fulfillment, the importance of inventory location accuracy increases. Lost items can result in teams of warehouse staff searching a facility.

Inventory Location Error Detection

Embodiments are designed to be able to identify and locate inventory that is in the wrong location and would be otherwise “lost” to the warehouse management systems. Reports are generated that automatically flag misplaced items. This reduces time spent searching for lost items at the time of shipment, shipment delays, and shipments that must be broken into multiple shipments.

Label Inaccuracy

Labels on inventory stock items are often incorrectly applied, not applied, torn off, or contain incorrect information. These errors can also lead to unnecessary costs.

Inventory Damage

Inventory can be damaged in multiple ways during its lifecycle in the warehouse. Items can be damaged when received in the warehouse, by forklifts and other machinery as they are moved. Discovery that an item is unsuitable for shipment during picking and shipment can lead to costly shipment delays. End-customer discovery of damage can lead to disputes.

Unplanned/Un-authorized Inventory Movement

Inventory items that move without those movements being authorized or recorded in the warehouse management system can be indicative of location errors, stray items, lost or stolen items.

Change Detection

Embodiments are designed to identify changes and flag those items for correction and reconciliation with the WMS. This results in improved inventory records accuracy and identification of theft.

Space Utilization Measurement

Embodiments are designed to be able to determine how efficiently inventory is stored in the warehouse by assessing the cubic space utilization of each pallet position. This provides inventory managers with tools to better plan how to optimize space in the warehouse. Warehouse managers must ensure that space is used optimally to manage costs. Inefficient utilization can lead to higher building lease costs, and operations shutdowns to re-allocate space.

Shipment Errors

As outbound items are staged to be loaded on trucks, specific items need to be checked and recorded to minimize the likelihood and cost of disputes with the transport company or receiver. These items include: presence of all items, proper labeling, presence and location of the bill of lading or customs paperwork, final check for packaging and damage, and photographic record of the shipment. Disputes resulting from errors in these items can encumber teams of people and many hours of labor, and often result in incurrence of losses.

Shipment QA

Embodiments are designed to create a visual record of all of the above to settle disputes quickly and in the favor of the warehouse operator. This reduces time and labor spent researching shipment disputes and improves the satisfaction of customers on the shipment receiving end.

What is claimed is:

1. A method for autonomous vehicle inventory inspection and management, comprising:
(a) having an autonomous vehicle docked at a base station, wherein the autonomous vehicle has at least two data acquisition systems, wherein the at least two data acquisition systems comprise at least one onboard camera and at least one onboard inertial sensor;
(b) having an indoor warehouse with rows of racks having shelves storing inventory, wherein the racks are organized in a distributed and substantially parallel fashion, and wherein passive identification markers are located on the racks for aiding navigation of the autonomous vehicle;
(c) defining a first path in the rows between the racks by a computer implemented digital warehouse management system, wherein the defined first path is a prescribed relatively straight path along the rows in between the racks, wherein the defined first path defines a substantially constant and lateral first distance relative to at least one of two racks along its row, a substantially constant first height relative to a warehouse floor and a substantially constant speed for the autonomous vehicle;
(d) at predefined intervals, launching the autonomous vehicle from the base station to continuously travel along the defined first path at the substantially constant speed until instructed to return back to the base station, wherein during travel the at least one onboard camera capturing the passive identification markers located on the racks and together with the at least one inertial sensor ensuring travel according to the defined path, and the at least two data acquisition systems capture information of the inventory and position on the racks;
(e) synchronizing the captured data at instantaneous locations of the autonomous vehicle with the computer implemented digital warehouse management system; and
(f) reconstructing inventory by the computer implemented digital warehouse management system based on the captured information of the inventory relative to a position on the rack, wherein the reconstructed inventory is a digital twin of the inventory in the warehouse.

2. The method as set forth in claim 1, wherein the autonomous vehicle is a flying autonomous vehicle or wherein the autonomous vehicle is a driving autonomous vehicle.

3. The method as set forth in claim 1, wherein the passive identification markers are labels, tags or barcodes.

4. The method as set forth in claim 1, wherein the substantially constant travel speed is about 0.1 to 3.5 m/sec.

5. The method as set forth in claim 1, wherein the computer implemented digital warehouse management system is further configured to digitally process the captured data for label or barcode readings, inventory item counting, inventory change detection, safety inspection, anomaly detection, workflow, inventory location accuracy, inventory location error detection, inventory label accuracy, inventory label error detection, inventory damage detection, inventory relocation, space utilization, space measurement, shipment errors, shipment or inventory inquiries, or any combination thereof.

6. The method as set forth in claim 1, wherein the captured information of the inventory is information about contour of the inventory, dimension of the inventory, image of the inventory, location of horizontal bars, vertical bars and uprights of the racks, distances of one or more faces of the inventory from the at least one onboard camera, color of the inventory on the shelves, color of the racks, or a combination thereof.

7. The method as set forth in claim 1, further comprising augmenting the defined first path with a second path, wherein the second path is defined in the rows between the racks, wherein the defined second path is a prescribed relatively straight path along the rows in between the racks, wherein the defined second path defines a substantially constant and lateral second distance relative to at least one of two racks along its row, a substantially constant second height relative to a warehouse floor and a substantially constant speed for the autonomous vehicle, wherein the defined first path and second path are different from each other.

8. The method as set forth in claim 1, wherein the indoor warehouse is a GPS-denied environment or an environment where a GPS signal is poor or inconsistent.

9. The method as set forth in claim 1, wherein the indoor warehouse is a dark environment or an environment with 50 Lumens or lower.

10. The method as set forth in claim 1, wherein the passive identification markers located on the racks are distributed on the racks.

11. The method as set forth in claim 1, wherein the passive identification markers for aiding navigation of the autonomous vehicle are further used for aiding in making corrections during travel to maintain the substantially constant and lateral first distance, the substantially constant first height, the substantially constant speed for the autonomous vehicle, or a combination thereof.

12. The method as set forth in claim 7, wherein the passive identification markers for aiding navigation of the autonomous vehicle are further used for aiding in making corrections during travel to maintain the substantially constant and lateral second distance, the substantially constant second height, the substantially constant speed for the autonomous vehicle, or a combination thereof.
